(19) United States
(12) Patent Application Publication
(10) Pub. No.: US 2008/0013605 A1
(43) Pub. Date: Jan. 17, 2008

(54) Method of GPS bit synchronization

(75) Inventor: Kuo-Wei Lin, Taoyuan City (TW)

Correspondence Address: BACON & THOMAS, PLLC, 625 SLATERS LANE, FOURTH FLOOR, ALEXANDRIA, VA, 22314, US

(73) Assignee: RoyalTek Company Ltd., Taoyuan City (TW)

(21) Appl. No.: 11/484,630

(22) Filed: Jul. 12, 2006

(51) Int. Cl. H04B 1/00

(52) U.S. Cl. 375/149

(57) ABSTRACT

A method of GPS bit synchronization is disclosed. The method includes the steps of a) receiving plural serial C/A Codes, wherein a data bit is formed by m C/A Codes; b) sequentially providing a bin number ranged from 0 to m−1 to the plural C/A Codes; c) setting a sampling value k; d) sequentially determining adjacent two C/A Codes, C/A Code nk and C/A Code (n+1)k, wherein n={0, 1, 2, 3, . . . }, and calculating a sign change aggregate value of each bin number ranged from 0 to m−1; e) repeating step d) till there are k bin numbers having the sign change aggregate value equal to or greater than a first threshold, and summing the k bin numbers for obtaining a lookup value; and f) acquiring a bit boundary of the data bit according to the lookup value in the plural serial C/A Codes.

### FIELD OF THE INVENTION

This invention relates to a method of processing GPS (Global Positioning System) reception signal, and more particularly to a method of GPS bit synchronization.

### BACKGROUND OF THE INVENTION

Generally speaking, a system of GPS receiver has to execute a bit synchronization process while the receiver is receiving and processing messages. Meanwhile, the bit synchronization process is executed for acquiring a data bit transition of serial C/A Codes (Coarse Acquisition Codes), which includes some messages of the GPS receiver for defining position and time. The prior art approaches that intention by means of the histogram technique (Van Dierendonck (1996)). Please refer to FIG. 1. It illustrates a method of GPS bit synchronization according to the prior art. A data bit has a period of 20 ms, and therefore the message of 20 ms could form a data bit. However, the position of a bit boundary should be found out for correctly obtaining a data bit. In general, when a data bit is divided into 20 C/A Codes of 1 ms, each C/A Code of 1 ms has a bin number, wherein there are 20 positions (0˜19) of the adjacent C/A Codes of 1 ms in sequence. When a satellite is locked on, the system of the receiver would try to check if there is a sign change of two adjacent C/A Codes of 1 ms. If the adjacent C/A Code of 1 ms have a sign change, the position thereof will be counted and the count is incremented by 1. When one of those positions of two adjacent C/A Codes has a counted amount over a first threshold, the bit boundary is located at that position with the counted amount over a first threshold. However, this method includes the following statuses: 1) When there are two positions of two adjacent C/A Codes having the counted amount over the second threshold, the bit synchronization process fails and restarts to find out the bit boundary. 2) When there is only one position of two adjacent C/A Codes having the counted amount over the first threshold, the bit synchronization process is successful and the position of two adjacent C/A Codes will be recorded.

The bit synchronization process might fail due to the low signal-to-noise ratio (C/No) or free of producing the sign change from that satellite. When the bit synchronization process has succeeded, the data bit of 20 ms could be defined according to the recorded position thereby obtaining subframes.

For a software GPS receiver, if the receiver should track satellites in real time, all satellites could not be tracked in the period of 1 ms between two adjacent C/A Codes. Therefore, the status of one position can't be obtained in each millisecond unless in a period ranged from 2 ms to 20 ms, and a different bit synchronization process is needed.

The prior art GPS bit synchronization couldn't be applied in the software GPS receiver. Therefore, it needs to provide a method of GPS bit synchronization for the software GPS receiver, which is capable of achieving GPS bit synchronization via fewer operations and processing steps, and can avoid those drawbacks of the prior art and solve the above problems. The present invention discloses a method of GPS bit synchronization in a software GPS receiver, wherein the GPS bit synchronization process is achieved via fewer operations and processing steps, and with a lookup table.

### SUMMARY OF THE INVENTION

It is an object of the present invention to provide a method of GPS bit synchronization for a software GPS receiver, which is capable of achieving GPS bit synchronization via fewer operations and processing steps by means of introducing a lookup value table.

In accordance with an aspect of the present invention, a method of GPS bit synchronization includes steps of a) receiving plural serial C/A Codes, wherein a data bit is formed by m C/A Codes; b) sequentially providing a bin number ranged from 0 to m−1to the plural C/A Codes; c) setting a sampling value k; d) sequentially determining adjacent two C/A Codes, C/A Code nk and C/A Code (n+1)k, wherein n={0, 1, 2, 3, . . . }, and calculating a sign change aggregate value of each bin number ranged from 0 to m−1; e) repeating step d) till there are k bin numbers having the sign change aggregate value equal to or greater than a first threshold, and summing the k bin numbers for obtaining a lookup value; and f) acquiring a bit boundary of the data bit according to the lookup value in the plural serial C/A Codes.

Certainly, m and k can be positive integers, relative prime with each other, and m>k.

Preferably, each of plural C/A Codes comprises a C/A Code of 1 ms.

Preferably, m=20, and the data bit is formed by C/A Codes of 20 ms.

Preferably, k=1, and the lookup value is a value selected from a group consisting of {0, 1, 2, 3, 4, 5, 6, 7, 8, 9, 10, 11, 12, 13, 14, 15, 16, 17, 18, and 19} and respectively indicates the bit boundary of the data bit disposed on the bin number of {0, 1, 2, 3, 4, 5, 6, 7, 8, 9, 10, 11, 12, 13, 14, 15, 16, 17, 18, and 19}.

Preferably, k=3, and the lookup value is a value selected from a group consisting of {3, 6, 9, 12, 15, 18, 21, 24, 27, 30, 33, 36, 39, 42, 45, 48, 51, 54, 37, and 20} and respectively indicates the bit boundary of the data bit disposed on the bin number of {0, 1, 2, 3, 4, 5, 6, 7, 8, 9, 10, 11, 12, 13, 14, 15, 16, 17, 18, and 19}.

Preferably, k=7, and the lookup value is a value selected from a group consisting of {21, 28, 35, 42, 49, 56, 63, 70, 77, 84, 91, 98, 105, 112, 99, 86, 73, 60, 47, and 34} and respectively indicates the bit boundary of the data bit disposed on the bin number of {0, 1, 2, 3, 4, 5, 6, 7, 8, 9, 10, 11, 12, 13, 14, 15, 16, 17, 18, and 19}.

Preferably, k=9, and the lookup value is a value selected from a group consisting of {36, 45, 54, 63, 72, 81, 90, 99, 108, 117, 126, 135, 124, 113, 102, 91, 80, 69, 58, and 47} and respectively indicates the bit boundary of the data bit disposed on the bin number of {0, 1, 2, 3, 4, 5, 6, 7, 8, 9, 10, 11, 12, 13, 14, 15, 16, 17, 18, and 19}.

Preferably, k=11, and the lookup value is a value selected from a group consisting of {55, 66, 77, 88, 99, 110, 121, 132, 143, 154, 145, 136, 127, 118, 109, 100, 91, 82, 73, and 64} and respectively indicates the bit boundary of the data bit disposed on the bin number of {0, 1, 2, 3, 4, 5, 6, 7, 8, 9, 10, 11, 12, 13, 14, 15, 16, 17, 18, and 19}.

Preferably, k=13, and the lookup value is a value selected from a group consisting of {78, 91, 104, 117, 130, 143, 156, 169, 162, 155, 148, 141, 134, 127, 120, 113, 106, 99, 92, and 85} and respectively indicates the bit boundary of the data bit disposed on the bin number of {0, 1, 2, 3, 4, 5, 6, 7, 8, 9, 10, 11, 12, 13, 14, 15, 16, 17, 18, and 19}.

Preferably, k=17, and the lookup value is a value selected from a group consisting of {136, 153, 170, 187, 184, 181, 178, 175, 172, 169, 166, 163, 160, 157, 154, 151, 148, 145, 142, and 139} and respectively indicates the bit boundary of the data bit disposed on the bin number of {0, 1, 2, 3, 4, 5, 6, 7, 8, 9, 10, 11, 12, 13, 14, 15, 16, 17, 18, and 19}.

Preferably, k=19, and the lookup value is a value selected from a group consisting of {171, 190, 189, 188, 187, 186, 185, 184, 183, 182, 181, 180, 179, 178, 177, 176, 175, 174, 173, and 172} and respectively indicates the bit boundary of the data bit disposed on the bin number of {0, 1, 2, 3, 4, 5, 6, 7, 8, 9, 10, 11, 12, 13, 14, 15, 16, 17, 18, and 19}.

Certainly, the step e) can further include a step of e1) repeating step d) till there are k+1 bin numbers having the sign change aggregate value equal to or greater than a second threshold, and initializing for restarting the step a), wherein the first threshold is larger then the second threshold.

In accordance with another aspect of the present invention, the method of GPS bit synchronization includes steps of a) setting a sampling value k; b) receiving plural serial C/A Codes, wherein a data bit is formed b m C/A Codes; c) sequentially providing a bin number ranged from 0 to m−1 to the plural C/A Codes; d) respectively providing a lookup value in response to each bin number ranged from 0 to m−1; e) sequentially determining adjacent two C/A Codes, C/A Code nk and C/A Code (n+1)k, wherein n={0, 1, 2, 3, . . . }, and calculating a sign change aggregate value of each bin number ranged from 0 to m−1; f) repeating step e) till there are k bin numbers having the sign change aggregate value equal to or greater than a first threshold, and summing the k bin numbers for obtaining one of the lookup values in response to the bin numbers ranged from 0 to m−1; and g) acquiring a bit boundary of the data bit according to the lookup value in the plural serial C/A Codes.

Certainly, m and k can be positive integers, relative prime with each other, and m>k.

Certainly, each of plural C/A Codes can comprise a C/A Code of 1 ms.

Preferably, m=20, and the data bit is formed by C/A Codes of 20 ms.

Preferably, k=1, and the lookup value is a value selected from a group consisting of {0, 1, 2, 3, 4, 5, 6, 7, 8, 9, 10, 11, 12, 13, 14, 15, 16, 17, 18, and 19} and respectively indicates the bit boundary of the data bit disposed on the bin number of {0, 1, 2, 3, 4, 5, 6, 7, 8, 9, 10, 11, 12, 13, 14, 15, 16, 17, 18, and 19}.

Preferably, k=3, and the lookup value is a value selected from a group consisting of {3, 6, 9, 12, 15, 18, 21, 24, 27, 30, 33, 36, 39, 42, 45, 48, 51, 54, 37, and 20} and respectively indicates the bit boundary of the data bit disposed on the bin number of {0, 1, 2, 3, 4, 5, 6, 7, 8, 9, 10, 11, 12, 13, 14, 15, 16, 17, 18, and 19}.

Preferably, k=7, and the lookup value is a value selected from a group consisting of {21, 28, 35, 42, 49, 56, 63, 70, 77, 84, 91, 98, 105, 112, 99, 86, 73, 60, 47, and 34} and respectively indicates the bit boundary of the data bit disposed on the bin number of {0, 1, 2, 3, 4, 5, 6, 7, 8, 9, 10, 11, 12, 13, 14, 15, 16, 17, 18, and 19}.

Preferably, k=9, and the lookup value is a value selected from a group consisting of {36, 45, 54, 63, 72, 81, 90, 99, 108, 117, 126, 135, 124, 113, 102, 91, 80, 69, 58, and 47} and respectively indicates the bit boundary of the data bit disposed on the bin number of {0, 1, 2, 3, 4, 5, 6, 7, 8, 9, 10, 11, 12, 13, 14, 15, 16, 17, 18, and 19}.

Preferably, k=11, and the lookup value is a value selected from a group consisting of {55, 66, 77, 88, 99, 110, 121, 132, 143, 154, 145, 136, 127, 118, 109, 100, 91, 82, 73, and 64} and respectively indicates the bit boundary of the data bit disposed on the bin number of {0, 1, 2, 3, 4, 5, 6, 7, 8, 9, 10, 11, 12, 13, 14, 15, 16, 17, 18, and 19}.

Preferably, k=13, and the lookup value is a value selected from a group consisting of {78, 91, 104, 117, 130, 143, 156, 169, 162, 155, 148, 141, 134, 127, 120, 113, 106, 99, 92, and 85} and respectively indicates the bit boundary of the data bit disposed on the bin number of {0, 1, 2, 3, 4, 5, 6, 7, 8, 9, 10, 11, 12, 13, 14, 15, 16, 17, 18, and 19}.

Preferably, k=17, and the lookup value is a value selected from a group consisting of {136, 153, 170, 187, 184, 181, 178, 175, 172, 169, 166, 163, 160, 157, 154, 151, 148, 145, 142, and 139} and respectively indicates the bit boundary of the data bit disposed on the bin number of {0, 1, 2, 3, 4, 5, 6, 7, 8, 9, 10, 11, 12, 13, 14, 15, 16, 17, 18, and 19}.

Preferably, k=19, and the lookup value is a value selected from a group consisting of {171, 190, 189, 188, 187, 186, 185, 184, 183, 182, 181, 180, 179, 178, 177, 176, 175, 174, 173, and 172} and respectively indicates the bit boundary of the data bit disposed on the bin number of {0, 1, 2, 3, 4, 5, 6, 7, 8, 9, 10, 11, 12, 13, 14, 15, 16, 17, 18, and 19}.

Certainly, the step f) can further include a step of f1) repeating step e) till there are k+1 bin numbers having the sign change aggregate value equal to or greater than a second threshold, and initializing for restarting the step a), wherein the first threshold is larger then the second threshold.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 illustrates a statistical chart of method of the histogram technique for GPS bit synchronization according to the prior art;

FIG. 2 illustrates a flowchart of method for GPS bit synchronization according to the present invention;

FIG. 3 illustrates a data bit with a bit boundary disposed on bin number 4 in plural serial C/A Codes;

FIG. 4 illustrates a histogram chart indicating a data bit of a bit boundary disposed on bin number 4 with k=3; and

FIG. 5 illustrates each lookup value in response to each bin number of a bit boundary according to the present invention.

### DETAILED DESCRIPTION OF THE PREFERRED EMBODIMENTS

The present invention discloses a method of GPS bit synchronization, and the objects and advantages of the present invention will become more readily apparent to those ordinarily skilled in the art after reviewing the following detailed description. The present invention needs not be limited to the following embodiment.

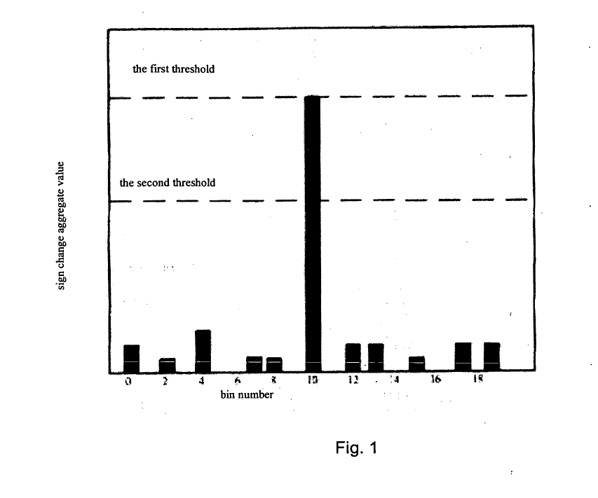

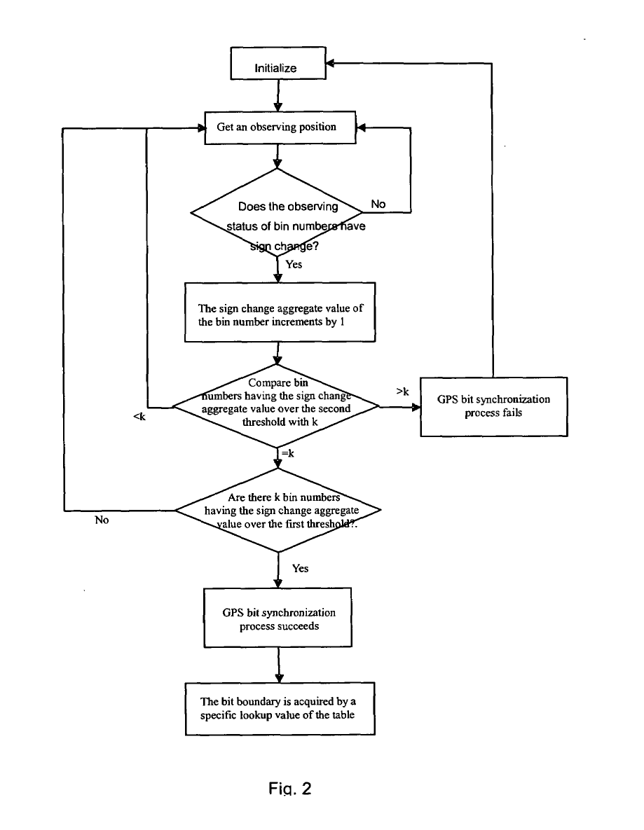

Please refer to FIG. 1. It illustrates a flowchart of method for GPS bit synchronization according to the present invention. In accordance with an aspect of the present invention, the method of GPS bit synchronization includes steps of a) receiving plural serial C/A Codes, wherein a data bit is formed by m C/A Codes; b) sequentially providing a bin number ranged from 0 to m−1 to the plural C/A Codes; c) setting a sampling value k; d) sequentially determining adjacent two C/A Codes, C/A Code nk and C/A Code (n+1)k, wherein n={0, 1, 2, 3, . . . }, and calculating a sign change aggregate value of each bin number ranged from 0 to m−1; e) repeating step d) till there are k bin numbers having the sign change aggregate value equal to or greater than a first threshold, and summing the k bin numbers for obtaining a lookup value; and f) acquiring a bit boundary of the data bit according to the lookup value in the plural serial C/A Codes. Meanwhile, m and k are positive integers, relative prime with each other, and m>k. Furthermore, each of plural C/A Codes comprises a C/A Code of 1 ms. When m=20, the data bit is formed by C/A Codes of 20 ms.

In accordance with another aspect of the present invention, the method of GPS bit synchronization includes steps of a) setting a sampling value k; b) receiving plural serial C/A Codes, wherein a data bit is formed by m C/A Codes; c) sequentially providing a bin number ranged from 0 to m−1 to the plural C/A Codes; d) respectively providing a lookup value in response to each bin number ranged from 0 to m−1; e) sequentially determining adjacent two C/A Codes, C/A Code nk and C/A Code (n+1)k, wherein n={0, 1, 2, 3, . . . }, and calculating a sign change aggregate value of each bin number ranged from 0 to m−1; f) repeating step e) till there are k bin numbers having the sign change aggregate value equal to or greater than a first threshold, and summing the k bin numbers for obtaining one of the lookup values in response to the bin numbers ranged from 0 to m−1; and g) acquiring a bit boundary of the data bit according to the lookup value in the plural serial C/A Codes. Certainly, m and k are positive integers, relative prime with each other, and m>k. Furthermore, each of plural C/A Codes comprises a C/A Code of 1 ms. When m=20, the data bit is formed by C/A Codes of 20 ms.

In practical GPS bit synchronization process, an determining status of bin numbers is obtained between adjacent two C/A Codes with 1 ms apart from each other. Certainly, the determining status of one bin number can also be obtained from two C/A Codes with k ms apart from each other. In the above embodiment, k=1 (ms), and the determining status of bin numbers is changed in a sequence of {0, 1, 2, 3, 4, 5, 6, 7, 8, 9, 10, 11, 12, 13, 14, 15, 16, 17, 18, and 19}, wherein all of the bin numbers are counteddetermined and counted without missing. Furthermore, the first threshold and the second threshold for GPS bit synchronization are 25 and 15 in the preferred embodiment. When there are k bin numbers having the sign change aggregate value over the first threshold, the GPS bit synchronization process is successful. Therefore, those k bin numbers are counted for obtaining a specific lookup value by an equation of

$$s = {\sum }_{q}^{q + k - 1} q ,$$

wherein 0<q<19, and then the bit boundary of the data bit is acquired by means of checking a table with lookup values, wherein the table is established responded to all of bin numbers in advance. The position of an array has a value of s can be acquired and transmitted a status of the position into ptr by a command of ptr=pos(s). When k=1, the table is established of {1, 2, 3, 4, 5, 6, 7, 8, 9, 10, 11, 12, 13, 14, 15, 16, 17, 18, and 19} in response to each bin number respectively.

In a practical software GPS receiver, if the receiver should track satellites in real time, all satellites could not be tracked in the period of 1 ms between two adjacent C/A Codes. Therefore, the status of one position can't be obtained in each millisecond (k=1) unless in a period ranged from 2 ms to 20 ms (k>1). If k=2(ms), the determining status of bin numbers is changed in a sequence of {0, 2, 4, 6, 8, 10, 12, 14, 16, and 18}, wherein some bin numbers are not counteddetermined and counted. Hence, k=2 is not included in the embodiment of the present invention. When a data bit is divided into 20 C/A Codes of 1 ms, k is ranged from 1 to 20. Meanwhile, the determining status should be disposed on all bin numbers sequentially, and k and 20 should be relative prime with each other. According to the above description, k can be merely a value selected from a group consisting of {1, 3, 7, 9, 11, 13, 17, and 19} for obtaining the determining status of all bin numbers without mixing. Every sequence of the determining status in response to each sampling value k is described in Table 1. For k=3, the determining status of all bin number could be obtained. When there are k bin numbers having the sign change aggregate value over the first threshold, a specific lookup value of those k bin numbers can be obtained by the equation of

$$s = {\sum }_{q}^{q + k - 1} q ,$$

wherein 0<q<19. Finally, the position of a bit boundary of the data bit can be acquired by means of looking up the table, thereby achieving GPS bit synchronization via the command of ptr=pos(s).

TABLE 1
Sequence of determining status in response to each sampling value k

| k value | changing sequence of determining status |
|---|---|
| k = 1 | 0 [symbol] 1 [symbol] 2 [symbol] 3 [symbol] 4 [symbol] 5 [symbol] 6 [symbol] 7 [symbol] 8 [symbol] 9 [symbol] 10 [symbol] |
| | 11 [symbol] 12 [symbol] 13 [symbol] 14 [symbol] 15 [symbol] 16 [symbol] 17 [symbol] 18 [symbol] 19 |
| k = 3 | 0 [symbol] 3 [symbol] 6 [symbol] 9 [symbol] 12 [symbol] 15 [symbol] 18 [symbol] 1 [symbol] 4 [symbol] 7 [symbol] |
| | 10 [symbol] 13 [symbol] 16 [symbol] 19 [symbol] 2 [symbol] 5 [symbol] 8 [symbol] 11 [symbol] 14 [symbol] 17 |
| k = 7 | 0 [symbol] 7 [symbol] 14 [symbol] 1 [symbol] 8 [symbol] 15 [symbol] 2 [symbol] 9 [symbol] 16 [symbol] 3 [symbol] |
| | 10 [symbol] 17 [symbol] 4 [symbol] 11 [symbol] 18 [symbol] 5 [symbol] 12 [symbol] 19 [symbol] 6 [symbol] 13 |
| k = 9 | 0 [symbol] 9 [symbol] 18 [symbol] 7 [symbol] 16 [symbol] 5 [symbol] 14 [symbol] 3 [symbol] 12 [symbol] 1 [symbol] |
| | 10 [symbol] 19 [symbol] 8 [symbol] 17 [symbol] 6 [symbol] 15 [symbol] 4 [symbol] 13 [symbol] 2 [symbol] 11 |
| k = 11 | 0 [symbol] 11 [symbol] 2 [symbol] 13 [symbol] 4 [symbol] 15 [symbol] 6 [symbol] 17 [symbol] 8 [symbol] 19 [symbol] |
| | 10 [symbol] 1 [symbol] 12 [symbol] 3 [symbol] 14 [symbol] 5 [symbol] 16 [symbol] 7 [symbol] 18 [symbol] 9 |
| k = 13 | 0 [symbol] 13 [symbol] 6 [symbol] 19 [symbol] 12 [symbol] 5 [symbol] 18 [symbol] 11 [symbol] 4 [symbol] 17 [symbol] |
| | 10 [symbol] 3 [symbol] 16 [symbol] 9 [symbol] 2 [symbol] 15 [symbol] 8 [symbol] 1 [symbol] 14 [symbol] 7 |
| k = 17 | 0 [symbol] 17 [symbol] 14 [symbol] 11 [symbol] 8 [symbol] 5 [symbol] 2 [symbol] 19 [symbol] 16 [symbol] 13 [symbol] |
| | 10 [symbol] 7 [symbol] 4 [symbol] 1 [symbol] 18 [symbol] 15 [symbol] 12 [symbol] 9 [symbol] 6 [symbol] 3 |
| k = 19 | 0 [symbol] 19 [symbol] 18 [symbol] 17 [symbol] 16 [symbol] 15 [symbol] 14 [symbol] 13 [symbol] 12 [symbol] |
| | 11 [symbol] 10 [symbol] 9 [symbol] 8 [symbol] 7 [symbol] 6 [symbol] 5 [symbol] 4 [symbol] 3 [symbol] 2 [symbol] 1 |

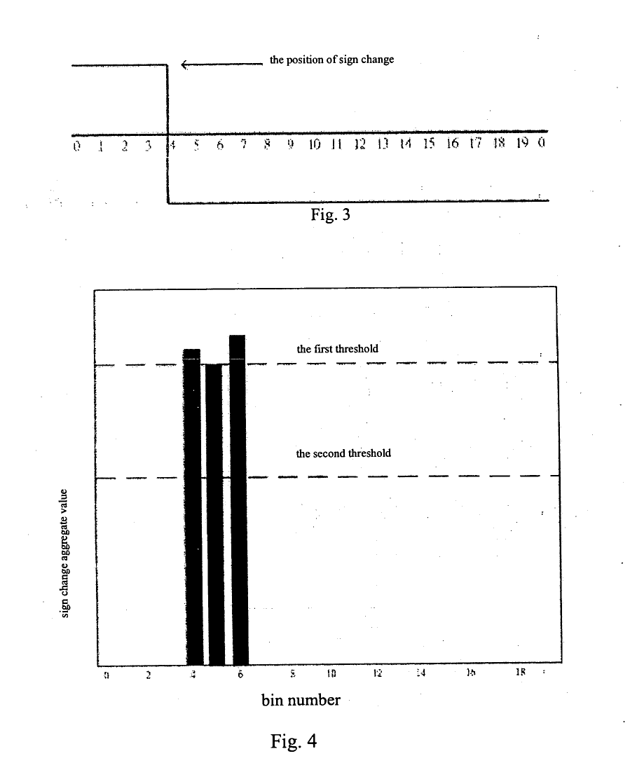

In a preferred embodiment of k=3 according to the present invention, when the position of the bit boundary of the data bit is disposed on the bin number 4, as shown in FIG. 3, the determining status of bin numbers has sign change in 1

[symbol]

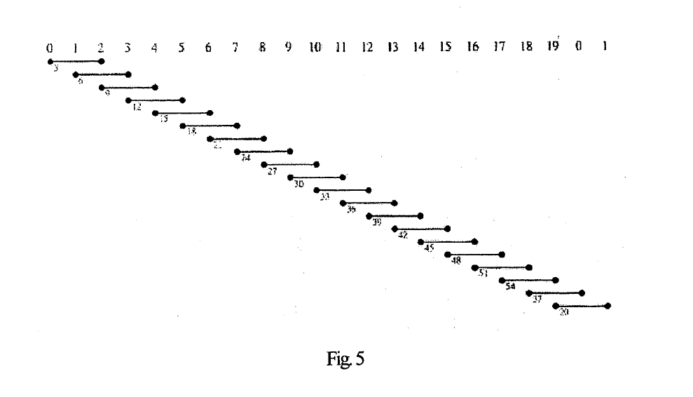

4, 2 [symbol]
5, 3 [symbol]
6. Hence, the bin numbers 4, 5, and 6 have the sign change aggregate value to be counted, respectively. Please refer to FIG. 4. It illustrates a successful result of GPS bit synchronization process with k=3, wherein there are 3 bin numbers having the sign change aggregate value over the first threshold, and those 3 bin numbers are counted to obtain a lookup value, i.e. 4+5+6=15, thereby acquiring that the bit boundary is disposed on the bin number 4 by means of looking up the table. FIG. 5 illustrates each lookup value for k=3 in response to each bin number of a bit boundary according to the present invention.

According to the aspect of the present invention, when k=1, the lookup value is a value selected from a group consisting of {0, 1, 2, 3, 4, 5, 6, 7, 8, 9, 10, 11, 12, 13, 14, 15, 16, 17, 18, and 19} and respectively indicates the bit boundary of the data bit disposed on the bin number of {0, 1, 2, 3, 4, 5, 6, 7, 8, 9, 10, 11, 12, 13, 14, 15, 16, 17, 18, and 19}.

When k=3, the lookup value is a value selected from a group consisting of {3, 6, 9, 12, 15, 18, 21, 24, 27, 30, 33, 36, 39, 42, 45, 48, 51, 54, 37, and 20} and respectively indicates the bit boundary of the data bit disposed on the bin number of {0, 1, 2, 3, 4, 5, 6, 7, 8, 9, 10, 11, 12, 13, 14, 15, 16, 17, 18, and 19}.

When k=7, the lookup value is a value selected from a group consisting of {21, 28, 35, 42, 49, 56, 63, 70, 77, 84, 91, 98, 105, 112, 99, 86, 73, 60, 47, and 34} and respectively indicates the bit boundary of the data bit disposed on the bin number of {0, 1, 2, 3, 4, 5, 6, 7, 8, 9, 10, 11, 12, 13, 14, 15, 16, 17, 18, and 19}.

When k=9, the lookup value is a value selected from a group consisting of {36, 45, 54, 63, 72, 81, 90, 99, 108, 117, 126, 135, 124, 113, 102, 91, 80, 69, 58, and 47} and respectively indicates the bit boundary of the data bit disposed on the bin number of {0, 1, 2, 3, 4, 5, 6, 7, 8, 9, 10, 11, 12, 13, 14, 15, 16, 17, 18, and 19}.

When k=11, the lookup value is a value selected from a group consisting of {55, 66, 77, 88, 99, 110, 121, 132, 143, 154, 145, 136, 127, 118, 109, 100, 91, 82, 73, and 64} and respectively indicates the bit boundary of the data bit disposed on the bin number of {0, 1, 2, 3, 4, 5, 6, 7, 8, 9, 10, 11, 12, 13, 14, 15, 16, 17, 18, and 19}.

When k=13, the lookup value is a value selected from a group consisting of {78, 91, 104, 117, 130, 143, 156, 169, 162, 155, 148, 141, 134, 127, 120, 113, 106, 99, 92, and 85} and respectively indicates the bit boundary of the data bit disposed on the bin number of {0, 1, 2, 3, 4, 5, 6, 7, 8, 9, 10, 11, 12, 13, 14, 15, 16, 17, 18, and 19}.

When k=17, the lookup value is a value selected from a group consisting of {136, 153, 170, 187, 184, 181, 178, 175, 172, 169, 166, 163, 160, 157, 154, 151, 148, 145, 142, and 139} and respectively indicates the bit boundary of the data bit disposed on the bin number of {0, 1, 2, 3, 4, 5, 6, 7, 8, 9, 10, 11, 12, 13, 14, 15, 16, 17, 18, and 19}.

When k=19, the lookup value is a value selected from a group consisting of {171, 190, 189, 188, 187, 186, 185, 184, 183, 182, 181, 180, 179, 178, 177, 176, 175, 174, 173, and 172} and respectively indicates the bit boundary of the data bit disposed on the bin number of {0, 1, 2, 3, 4, 5, 6, 7, 8, 9, 10, 11, 12, 13, 14, 15, 16, 17, 18, and 19}.

According to the present invention, a lookup value table, shown in Table 2, is disclosed, wherein each bin number has a specific lookup value in response to each k value. It is capable of achieving GPS bit synchronization via fewer operations and processing steps by means of introducing the lookup value table.

TABLE 2
each lookup value of each bin number in response to each k value

| | Bin no | | | | | | | | | | | | | | | | | | | |
|---|---|---|---|---|---|---|---|---|---|---|---|---|---|---|---|---|---|---|---|---|
| k | 0 | 1 | 2 | 3 | 4 | 5 | 6 | 7 | 8 | 9 | 10 | 11 | 12 | 13 | 14 | 15 | 16 | 17 | 18 | 19 |
| 1 | 0 | 1 | 2 | 3 | 4 | 5 | 6 | 7 | 8 | 9 | 10 | 11 | 12 | 13 | 14 | 15 | 16 | 17 | 18 | 19 |
| 3 | 3 | 6 | 9 | 12 | 15 | 18 | 21 | 24 | 27 | 30 | 33 | 36 | 39 | 42 | 45 | 48 | 51 | 54 | 37 | 20 |
| 7 | 21 | 28 | 35 | 42 | 49 | 56 | 63 | 70 | 77 | 84 | 91 | 98 | 105 | 112 | 99 | 86 | 73 | 60 | 47 | 34 |
| 9 | 36 | 45 | 54 | 63 | 72 | 81 | 90 | 99 | 108 | 117 | 126 | 135 | 124 | 113 | 102 | 91 | 80 | 69 | 58 | 47 |
| 11 | 55 | 66 | 77 | 88 | 99 | 110 | 121 | 132 | 143 | 154 | 145 | 136 | 127 | 118 | 109 | 100 | 91 | 82 | 73 | 64 |
| 13 | 78 | 91 | 104 | 117 | 130 | 143 | 156 | 169 | 162 | 155 | 148 | 141 | 134 | 127 | 120 | 113 | 106 | 99 | 92 | 85 |
| 17 | 136 | 153 | 170 | 187 | 184 | 181 | 178 | 175 | 172 | 169 | 166 | 163 | 160 | 157 | 154 | 151 | 148 | 145 | 142 | 139 |
| 19 | 171 | 190 | 189 | 188 | 187 | 186 | 185 | 184 | 183 | 182 | 181 | 180 | 179 | 178 | 177 | 176 | 175 | 174 | 173 | 172 |

In conclusion, the present invention provides a method of GPS bit synchronization for a software GPS receiver, which is capable of achieving GPS bit synchronization via fewer operations and processing steps by means of introducing a lookup value table, while the prior art fails to disclose that. Accordingly, the present invention possesses many outstanding characteristics and effectively overcomes the drawbacks associated with the prior art. Therefore, the present invention exhibits a great industrial value.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A method of GPS bit synchronization, comprising the steps of:
a) receiving plural serial C/A Codes, wherein a data bit is formed by m C/A Codes;
b) sequentially providing a bin number ranged from 0 to m−1 to said plural C/A Codes;
c) setting a sampling value k;
d) sequentially determining adjacent two C/A Codes, C/A Code nk and C/A Code (n+1)k, wherein n={0, 1, 2, 3, . . . }, and calculating a sign change aggregate value of each bin number ranged from 0 to m−1;
e) repeating step d) till there are k bin numbers having said sign change aggregate value equal to or greater than a first threshold, and summing said k bin numbers for obtaining a lookup value; and
f) acquiring a bit boundary of said data bit according to said lookup value in said plural serial C/A Codes.

2. The method of GPS bit synchronization according to claim 1, wherein m and k are positive integers, relative prime with each other, and m>k.

3. The method of GPS bit synchronization according to claim 1, wherein each of said plural C/A Codes comprises a C/A Code of 1 ms.

4. The method of GPS bit synchronization according to claim 1, wherein m=20, and said data bit is formed by C/A Codes of 20 ms.

5. The method of GPS bit synchronization according to claim 4, wherein said k=1, and said lookup value is a value selected from a group consisting of {0, 1, 2, 3, 4, 5, 6, 7, 8, 9, 10, 11, 12, 13, 14, 15, 16, 17, 18, and 19} and respectively indicates said bit boundary of said data bit disposed on said bin number of {0, 1, 2, 3, 4, 5, 6, 7, 8, 9, 10, 11, 12, 13, 14, 15, 16, 17, 18, and 19}.

6. The method of GPS bit synchronization according to claim 4, wherein said k=3, and said lookup value is a value selected from a group consisting of {3, 6, 9, 12, 15, 18, 21, 24, 27, 30, 33, 36, 39, 42, 45, 48, 51, 54, 37, and 20} and respectively indicates said bit boundary of said data bit disposed on said bin number of {0, 1, 2, 3, 4, 5, 6, 7, 8, 9, 10, 11, 12, 13, 14, 15, 16, 17, 18, and 19}.

7. The method of GPS bit synchronization according to claim 4, wherein said k=7, and said lookup value is a value selected from a group consisting of {21, 28, 35, 42, 49, 56, 63, 70, 77, 84, 91, 98, 105, 112, 99, 86, 73, 60, 47, and 34} and respectively indicates said bit boundary of said data bit disposed on said bin number of {0, 1, 2, 3, 4, 5, 6, 7, 8, 9, 10, 11, 12, 13, 14, 15, 16, 17, 18, and 19}.

8. The method of GPS bit synchronization according to claim 4, wherein said k=9, and said lookup value is a value selected from a group consisting of {36, 45, 54, 63, 72, 81, 90, 99, 108, 117, 126, 135, 124, 113, 102, 91, 80, 69, 58, and 47} and respectively indicates said bit boundary of said data bit disposed on said bin number of {0, 1, 2, 3, 4, 5, 6, 7, 8, 9, 10, 11, 12, 13, 14, 15, 16, 17, 18, and 19}.

9. The method of GPS bit synchronization according to claim 4, wherein said k=11, and said lookup value is a value selected from a group consisting of {55, 66, 77, 88, 99, 110, 121, 132, 143, 154, 145, 136, 127, 118, 109, 100, 91, 82, 73, and 64} and respectively indicates said bit boundary of said data bit disposed on said bin number of {0, 1, 2, 3, 4, 5, 6, 7, 8, 9, 10, 11, 12, 13, 14, 15, 16, 17, 18, and 19}.

10. The method of GPS bit synchronization according to claim 4, wherein said k=13, and said lookup value is a value selected from a group consisting of {78, 91, 104, 117, 130, 143, 156, 169, 162, 155, 148, 141, 134, 127, 120, 113, 106, 99, 92, and 85} and respectively indicates said bit boundary of said data bit disposed on said bin number of {0, 1, 2, 3, 4, 5, 6, 7, 8, 9, 10, 11, 12, 13, 14, 15, 16, 17, 18, and 19}.

11. The method of GPS bit synchronization according to claim 4, wherein said k=17, and said lookup value is a value selected from a group consisting of {136, 153, 170, 187, 184, 181, 178, 175, 172, 169, 166, 163, 160, 157, 154, 151, 148, 145, 142, and 139} and respectively indicates said bit boundary of said data bit disposed on said bin number of {0, 1, 2, 3, 4, 5, 6, 7, 8, 9, 10, 11, 12, 13, 14, 15, 16, 17, 18, and 19}.

12. The method of GPS bit synchronization according to claim 4, wherein said k=19, and said lookup value is a value selected from a group consisting of {171, 190, 189, 188, 187, 186, 185, 184, 183, 182, 181, 180, 179, 178, 177, 176, 175, 174, 173, and 172} and respectively indicates said bit boundary of said data bit disposed on said bin number of {0, 1, 2, 3, 4, 5, 6, 7, 8, 9, 10, 11, 12, 13, 14, 15, 16, 17, 18, and 19}.

13. The method of GPS bit synchronization according to claim 1, wherein said step e) further comprises a step of
e1) repeating step d) till there are k+1 bin numbers having said sign change aggregate value equal to or greater than a second threshold, and initializing for restarting said step a), wherein said first threshold is larger then said second threshold.

14. A method of GPS bit synchronization, comprising the steps of:
a) setting a sampling value k;
b) receiving plural serial C/A Codes, wherein a data bit is formed by m C/A Codes;
c) sequentially providing a bin number ranged from 0 to m−1 to said plural C/A Codes;
d) respectively providing a lookup value in response to each bin number ranged from 0 to m−1;
e) sequentially determining adjacent two C/A Codes, C/A Code nk and C/A Code (n+1)k, wherein n={0, 1, 2, 3, . . . }, and calculating a sign change aggregate value of each bin number ranged from 0 to m−1;
f) repeating step e) till there are k bin numbers having said sign change aggregate value equal to or greater than a first threshold, and summing said k bin numbers for obtaining one of said lookup values in response to said bin numbers ranged from 0 to m−1; and
g) acquiring a bit boundary of said data bit according to said lookup value in said plural serial C/A Codes.

15. The method of GPS bit synchronization according to claim 14, wherein m and k are positive integers, relative prime with each other, and m>k.

16. The method of GPS bit synchronization according to claim 14, wherein each of said plural C/A Codes comprises a C/A Code of 1 ms.

17. The method of GPS bit synchronization according to claim 14, wherein m=20, and said data bit is formed by C/A Codes of 20 ms.

18. The method of GPS bit synchronization according to claim 14, wherein said step f) further comprises a step of
f1) repeating step e) till there are k+1 bin numbers having said sign change aggregate value equal to or greater than a second threshold, and initializing for restarting said step a), wherein said first threshold is larger then said second threshold.
